(19) United States
(12) Patent Application Publication
(10) Pub. No.: US 2007/0156279 A1
(43) Pub. Date: Jul. 5, 2007

(54) Molding machine having human-machine interface

(75) Inventor: Richard Kent Dalley, Mississauga (CA)

Correspondence Address: HUSKY INJECTION MOLDING SYSTEMS, LTD;CO/AMC INTELLECTUAL PROPERTY GRP, 500 QUEEN ST. SOUTH, BOLTON, ON, L7E 5S5, CA

(73) Assignee: Husky Injection Molding Systems Ltd.

(21) Appl. No.: 11/253,412

(22) Filed: Oct. 19, 2005

(51) Int. Cl. B29C 39/00

(52) U.S. Cl. 700/197

(57) ABSTRACT

Disclosed is a human-machine interface, a molding machine, a computer system and a method. The human-machine interface includes a display of a computer system configured to display a molding-machine function curve, the molding-machine function curve representing a function of the molding machine, the display configured to display an emphasized point associated with the molding-machine function curve.

### TECHNICAL FIELD OF THE INVENTION

The present invention generally relates to molding machines, and more specifically the present invention relates to a human-machine interface of a molding machine, a molding machine having a human-machine interface, a computer system having a human-machine interface, and a method of a human-machine interface.

### BACKGROUND

FIG. 1 is a representation of known art related to human-machine interfaces of molding machines.

U.S. Pat. No. 5,470,218 (Inventor: Hillman et al; Assignee: Wheaton Inc., USA) discloses an apparatus for an injection blow molding machine having work stations and molds. The apparatus includes a process controller for operating the blow molding machine according to a set of processing parameters. Each processing parameter has a respective desired operating range. The apparatus includes a touch screen for inputting signals to the processor for commanding the process controller to adjust the processing parameters. Display software and hardware coupled to the process controller and the touch screen cause the monitor to display respective icons representing each processing parameter. The value of each respective processing parameter is displayed adjacent to the icon. Graphing software generates signals that are transmitted to the monitor. The monitor displays a graph of the selected processing parameter value as a function of time. The graph is plotted in response to an operator touching a portion of the touch screen beneath which the selected icon is displayed. Alarm software causes the monitor to display an alarm message. The alarm message identifies whether any one of the processing parameters is operating outside its desired operating range. Referring to FIG. 5 and quoting column 8, lines 28 to 45 of the 5,470,218 patent: “FIG. 5 shows the injection control window 1130 which is displayed when button 1006 is selected from window 1000 or another window. The user uses this window to adjust several parameters affecting the injection of the melt into the injection mold 40. An injection profile box 1132 includes a set of 10 slideable control switches for adjusting the fraction of the inject velocity applied during ten different intervals in the injection of a single shot. When the desired inject velocity profile has been entered, the user selects the transmit profile button 1152 to send the velocity profile data to the process controller. When the next profile button 1154 is selected, eight slideable control switches (not shown) similar to those shown in FIG. 5 are displayed. These eight switches are used to control the pack pressure profile over time. In normal operation, using the exemplary control system, the injection screw is initially controlled using the inject velocity profile. Subsequently, the control may switch over to use the pressure profile”. Disadvantageously, the display of the eight switches does not give an intuitive sense of the shape of the inject velocity profile to the operator or user of the molding machine.

U.S. Pat. No. 6,684,264 (Inventor: Choi; Assignee: Husky Injection Molding Systems Limited, Canada) discloses an apparatus and a method for controlling a molding machine that includes structure and function for a human machine interface control panel. The panel has: (i) a flat panel display screen; (ii) a pointing device; (iii) a plurality of pushbuttons overlaid with or without icons; (iv) a housing containing the above and the associated electronics; (v) structure to uniquely identify each user-preferred configuration; (vi) structure to connect to a remote controller for both digital information and video signal communication; (vii) a connection for receiving external power to drive the display electronics of the panel; and (viii) software running in the remote controller to provide all the operating functions of the human machine interface. Disadvantageously, this approach does not provide an easy and convenient way of allowing the user of the molding machine to change a parameter profile according to the needs of the user.

U.S. Pat. No. 6,066,276 (Inventor: Kamiguchi et al; Assignee: Fanuc Ltd., Yamanashi, Japan) discloses a correlation between an injection stage and an injection speed initially set in an injection condition file that is graphically displayed on a display screen. A modification section is set by assigning a starting point and an end point on the graph. Then, the shape of a segment which connects the starting point and the end point is selected and assigned. Thus, a section between the two points constitutes one new injection stage. In this new injection stage, moreover, the injection speed is not always a constant value, and can be optionally set so that it linearly increases or decreases or changes along a circular arc in this section. Referring to column 1, lines 40 to 56: “In order to achieve the above object, according to one aspect of the present invention, (a) coordinates having two rectangular axes are displayed on a screen, one of the axes representing the position of a screw, the other representing the injection speed; (b) a section from a first screw position to a second screw position, out of an overall movement section of the screw, is defined as a first injection stage; (c) a first injection speed corresponding to the first screw position and a second injection speed corresponding to the second screw position are determined individually; (d) a point representing the relation of the first injection speed and the first screw position and a point representing the relation of the second injection speed and the second screw position are displayed as a starting point and an end point of the first injection stage, respectively, on the rectangular coordinates; (e) a line connecting the starting point and the end point of the first injection stage displayed on the screen”. Disadvantageously, this approach does not provide an easy and convenient way of allowing the user of the molding machine to change a profile according to the needs of the user.

U.S. Pat. No. 6,618,041 (Inventor: Nishizawa; Assignee: Nissei Plastic Industrial Company Limited, Japan) discloses an input device for an injection molding machine, having a touch panel-type display screen. The display screen has set value displays for displaying set values of molding conditions. The set value display consists of a plurality of set value windows. Touching one of the set value windows makes an input element for inputting a set value of the molding conditions become displayed on the display screen. The input element constitutes a scale. Touching the scale changes numerical values displayed in the set value windows. Referring to FIG. 2 and quoting column 2 line 61 to column 3 line 2 of the 6,618,041 patent: “The set value windows 32 and 33 indicate numerical values of the molding conditions (“temperatures” such as heating barrel temperatures and mold temperature, “pressures” such as injection pressure and screw back pressure, “times” such as injection time and dwell time, “speeds” such as injection speed a screw rotation speed, “positions” of the screw and the nozzle, the volume of production, the number of cavities, the number of stages of multistage control, and other conditions)”. Referring to FIG. 5A and quoting from column 3 lines 23 to 34 of the 6,618,041 patent: “In FIG. 5A, the linear scale 41 has ten notches (not shown correctly in the figure). The uppermost notch is assigned a maximum value (maximum value allowed in the set value window 32) and the lowermost notch is assigned a minimum value. Here suppose that the minimum value of the setting range of the set value window 32 is 0 and the maxim value is 400. A finger 49 touching a 70% point changes the set value window 32 to a temperature of 280.0° C. corresponding to the 70% point. The finger 49 touches different points to change a numerical value of the set value window 32 shown on the right of the scale 40 accordingly”. Disadvantageously, the display of the eight switches does not give an intuitive sense of the shape of the inject velocity profile to the operator or user of the molding machine.

### SUMMARY

In a first aspect of the present invention, there is provided a human-machine interface of a molding machine, including a display of a computer system configured to display a molding-machine function curve, the molding-machine function curve representing a function of the molding machine, and also including an emphasized point associated with the molding-machine function curve.

In a second aspect of the present invention, there is provided a molding machine, including a human-machine interface, the interface including a display of a computer system configured to display a molding-machine function curve, the molding-machine function curve representing a function of the molding machine, and also including an emphasized point associated with the molding-machine function curve.

In a third aspect of the present invention, there is provided a computer system of a molding machine, including a human-machine interface, the interface including a display configured to display a molding-machine function curve, the molding-machine function curve representing a function of the molding machine, and also including an emphasized point associated with the molding-machine function curve.

In a fourth aspect of the present invention, there is disclosed a method of a human-machine interface of a molding machine, including displaying a molding-machine function curve, the molding-machine function curve representing a function of the molding machine, and displaying an emphasized point associated with the molding-machine function curve.

A technical effect of the aspects of the present invention is that a user (that is an operator) of a molding machine is provided with an improved approach for adjusting a molding-machine function curve (hereafter called “the curve’) by emphasizing a point of the curve (for example, by visually emphasizing the point) so that the user can easily (and with less user-selection error) select a desired emphasized point of the curve, and adjust the selected emphasized point as needed for adjusting and/or optimizing a function of the molding machine. This arrangement helps to minimize user error associated with selecting and/or adjusting points of the curve.

### BRIEF DESCRIPTION OF THE DRAWINGS

A better understanding of the exemplary embodiments of the present invention (including alternatives and/or variations thereof may be obtained with reference to the detailed description of the exemplary embodiments along with the following drawings, in which:

FIG. 1 is the representation of known art;

FIGS. 2A and 2B are representations of a human-machine interface according to the first embodiment of the present invention;

FIG. 3 is a representation of a point-manipulation tool bar and an information panel of a selected point of the human-machine interface of FIG. 2B;

FIG. 4 is a representation of a human-machine interface according to the second embodiment of the present invention;

FIG. 5 is a representation of a human-machine interface according to the third embodiment of the present invention;

FIG. 6 is a representation of tables associated with curves displayed in the human-machine interface of FIG. 5; and

FIGS. 7A and 7B are representations of human-machine interfaces according to the fourth embodiment and the fifth embodiment of the present invention.

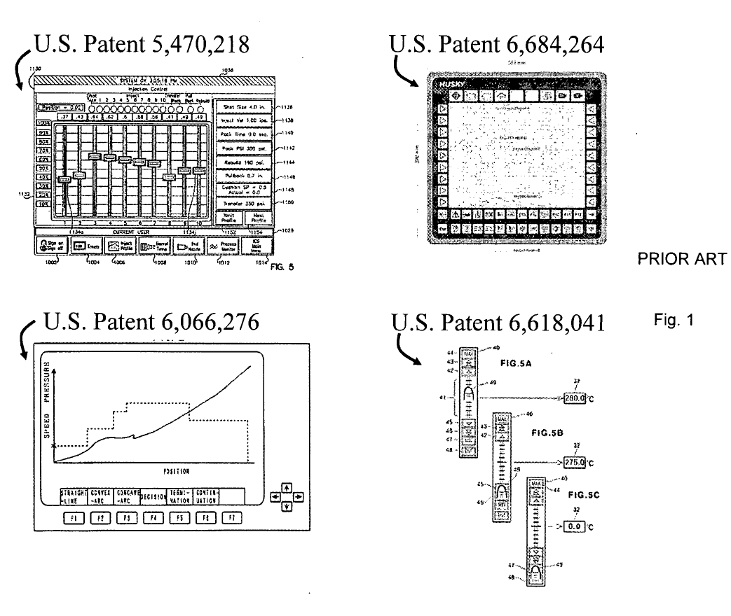

The following is a listing of components shown in the FIGS:
human-machine interface 100 molding machine 101
molding-machine clamp 101A injection piston 101B
display 102 computer system 103
connection hardware 103A molding-machine function curve 104
molding-machine function curve 105 emphasized point 114
shape indicator 107A color indicator 107B
point manipulation mechanism 107C emphasized points 108 to 118
view menu 120 point-manipulation toolbar 122
information panel 124 control buttons 202 to 218
zoom-control button 202 dragging-control button 204
switch-view control button 206 table control button 208
properties control button 210 size-control button 212
add-point control button 214 delete-point control button 216
nudge-control button 218
set of emphasized-point attributes 119 identifier attribute 220
graph-coordinate attributes 222 graph-coordinate attributes 224
human-machine interface 300 display 301
molding machine injection profile 302 point-manipulation toolbar 304
molding-machine hold profile 306 point-manipulation tool bar 308
profile-properties panel 310 human-machine interface 400
display 401 injection-profile table 402
hold-profile table 404 Y-value coordinates 502
X-value coordinates 504 Y-value coordinates 506
X-value coordinates 508 table portion 510
human-machine interface 700 display 702
injection curve 703 injection-profile table 704
fill tab 706 switch-view control button 708
human-machine interface 710 display 711
injection-profile curve 712 hold-profile curve 714
injection-profile information panel 716 hold-profile information panel 718

### DETAILED DESCRIPTION OF THE EXEMPLARY EMBODIMENTS

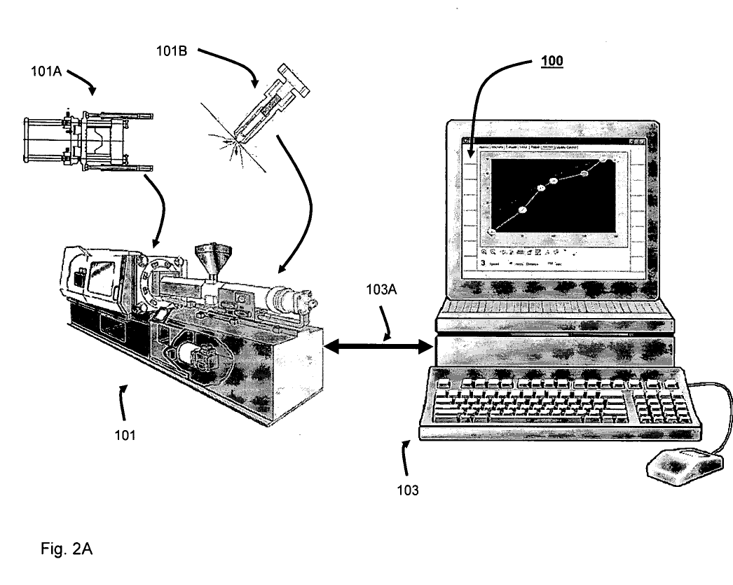

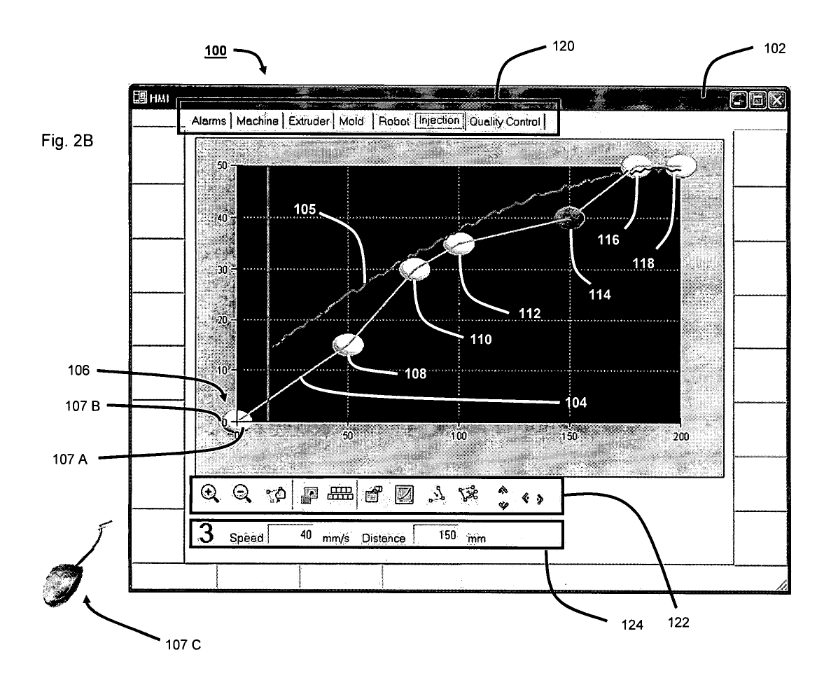

FIGS. 2A and 2B are representations of a human-machine interface 100 according to the first embodiment (which is the preferred embodiment).

Referring to FIG. 2A, the human-machine interface 100 is operatively attachable to a molding machine 101 via a computer system 103 and connection hardware 103A. The molding machine 101 includes movable molding-machine parts, such as (for example) a molding-machine clamp 101A and an injection piston 101B. A movable molding-machine part includes a single part and/or an assembly of assembled parts and/or a collection of assembled parts and/or a combination of components.

The system 103 includes computer-executable instructions for directing the system 103 to implement the human-machine interface 100 and to interact with the interface 100. The instructions are stored in a computer-readable medium and/or data structure, such floppy diskettes, hard drives, CD-ROMs, RAMs, EEPROMs, magnetic media, optical media, magneto-optical media, etc.

Referring to FIG. 2B, the human-machine interface 100 includes a display 102 configured to display a molding-machine function curve 104 (hereafter referred to as the “curve” 104). The curve 104 represents a predetermined function to be executed by the molding machine 101, such as, for example, an injection-function profile or a hold-function profile associated with the molding machine 101. The molding machine 101 operates under the control of the computer system 103. For the injection-function profile, the molding machine 101 operates or functions (as directed by the computer system 103) to inject according to a predetermined profile (that is, so much molding material is injected over a determined period of time). For the hold-function profile, the molding machine 101 operates or functions (as directed by the computer system 103) to hold a mold shut for a predetermined duration of time at a predetermined pressure level. Information displayed by the human-machine interface 100 is computed and provided by the computer system 103.

A molding-machine function curve 105 (hereafter called the “curve” 105) represents a most-recently executed profile of the molding machine 101. The curve 104 is a user-determined (predetermined) curve (or profile) in which the molding machine 101 is required to execute according to a shape of the curve 104 that was predefined by a user of the molding machine 101 or as automatically determined by the computer system 103. It will be appreciated that there is a difference between the actual performance of the molding machine 101 (as indicated by the curve 105) versus the desired performance (as indicated by the curve 104).

The curve 104 includes an emphasized point 114 being sufficiently emphasized so that a user of the molding machine 101 can easily detect the emphasized point 114 from other components of the display 102 (such as, for example, the curve 104). A technical advantage of this arrangement is that the emphasized point 114 is easily and quickly identifiable for a user, so that the user can, in turn, select a desired emphasized point (without mistakenly selecting the wrong point), and then the user may change an attribute associated the selected emphasized point. The emphasized point 114 is emphasized by a shape indicator 107A. The shape indicator 107A emphasizes the point 106 by, for example, being a circle or a square or a triangle (etc) that is filled in part or filled in whole. According to a variation, the shape indicator 107A emphasizes the point 106 by being a color indicator (such as, for example, a white-colored shape or another color that does not match a color of the curve 104). The emphasized point 114 is display manipulatable responsive to user interaction with a point-manipulation mechanism 107C attached to the computer system 103. Preferably, the point-manipulation mechanism 107C includes, for example, a touch-sensitive screen and/or a mouse pointer, and/or a point-manipulation toolbar.

A technical effect of the first embodiment is that the user (that is an operator) of the molding machine 101 is provided with an improved and convenient approach for adjusting the molding-machine function curve by emphasizing a point of the curve 104 so that the user can conveniently and easily select the emphasized point, and then adjust the selected emphasized point more accurately and quickly for the purpose of adjusting and optimizing operation of the molding machine 101. This approach reduces time needed to adjust the curve 104, and also reduces the chance of molding articles that are not acceptable from a quality point of view.

Preferably, the emphasized point 114 is a member of a set of emphasized points 106 to 118 inclusive. Stated in an equivalent manner: the emphasized point 114 is included in a set of emphasized points 106 to 118. The set of emphasized points are alternatively called a set of “break” points. The set of emphasized points are each highlighted, for example, in a white color. A number of emphasized points to be displayed are user programmable or user selectable. A user-selected emphasized point 114 is highlighted or emphasized in a different color (such as, for example, blue or red, etc) or a different shape (such as, for example, a triangle shape, square shape, etc) relative to the other emphasized points 106, 108, 110, 112, 114 and 118 (that are colored white and are circular shaped). In a variation of the first embodiment, the emphasized point 114 is user selected by placing the display 102 on a touch sensitive screen and having the user merely touch the screen at the emphasized point 114 to highlight the emphasized point 114 differently in view of the other emphasized points. In another variation of the first embodiment, the user uses a mouse pointing device or a track ball to select the emphasized point 114.

Preferably, the molding machine 101 includes a control assembly that controls the function of the molding machine 101 (and/or controls a movable molding-machine part), and the display 102 is operatively coupled to the control assembly. The curve 104 includes, for example, a molding machine 101 injection profile and/or a molding machine 101 hold profile. The curve 104 is used by the computer system 103 to control motion of a movable molding-machine part or a function of the molding machine 101. The computer system 103 includes executable programmed instructions that use information associated with the curve 104 for the purpose of controlling motion of the movable molding-machine part and/or the function of the molding machine 101. The movable molding-machine part includes, for example, the molding-machine clamp 101A and/or the injection piston 101B. The curve 104 is used, for example, to control speed, acceleration, deceleration of the movable molding-machine part.

In a variation, the human-machine interface 100 also includes a view menu 120 used to guide the user to select another view used to control and/or monitor other aspects of the molding machine 101. In another variation, the human-machine interface 100 includes a point-manipulation toolbar 122 that is described further below. In yet another variation, the human-machine interface 100 includes an information panel 124 of a selected emphasized point (such as, for example, the selected emphasized point is the point 106). The information panel 124 shows coordinates of a user-selected emphasized point.

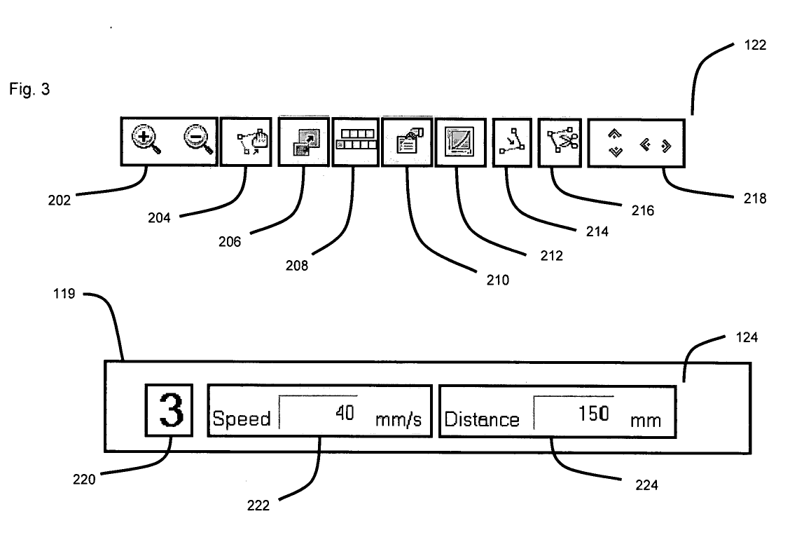

FIG. 3 is a representation of the point-manipulation tool bar 122 and is also a representation of the information panel 124 both included in the human-machine interface 100 of FIG. 2B.

The point-manipulation tool bar 122 includes a plurality of control buttons 202 to 218 inclusive that are used for manipulating the emphasized points 106 to 118 of the curve 104.

A zoom-control button 202 permits the user to activate zoom functions for zooming in and/or zooming out of a user-selected portion of the curve 104.

A dragging-control button 204 permits the user to activate and deactivate dragging of the user-selected emphasized point 114. The control button 204 is used for approximate tuning of coordinates of a user-selected emphasized point. When activated, the user points and drags a selected emphasized point to a new coordinate location on the display 102 (either by, for example, using a touch-sensitive screen or by using a mouse to click and drag the selected emphasized point).

A switch-view control button 206 permits the user to switch between embodiments of the human-machine interface 100.

A table control button 208 enables the user to view or hide a table of emphasized points. The table shows the coordinate values of the emphasized points as is further described below.

A properties-control button 210 enables the user to view or hide properties associated with the curve 104 as is further described below.

A size-control button 212 permits the user to toggle between predetermined sizes of the curve 104, such as a largest curve size, an intermediate curve size and a smallest curve size. This arrangement permits the display of more information on the display 102 along with the smaller curve sizes.

An add-point control button 214 enables the user to add a new emphasized point to the curve 104.

A delete-point control button 216 enables the user to delete an existing emphasized point from the curve 104.

A nudge-control button 218 enables the user to nudge a selected emphasized point in a predetermined direction (that is, nudge the emphasized point to the right, the left, upwardly, and/or downwardly) by a preset incremental amount. This arrangement permits fine tuning of coordinate values of the user-selected emphasized point.

The information panel of a selected point 124 includes a set of emphasized-point attributes 119 of a user-selected emphasized point. The set 119 includes attributes 220, 222, 224. The identifier attribute 220 that is an emphasized-point identifier (in this case, point “3” is identified). Graph-coordinate attributes 222 and 224 are coordinates of the emphasized point. In this case, for example, the speed coordinate is 40 mm/s (millimeters per second) and the distance coordinate is 150 mm (millimeters). The user uses a key pad to enter new coordinate values.

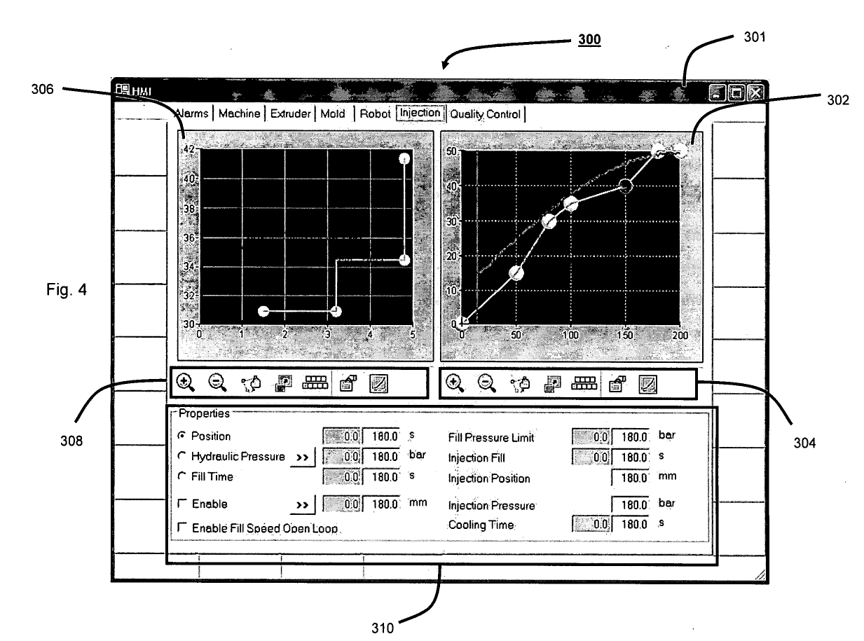

FIG. 4 is a representation of a human-machine interface 300 according to the second embodiment. The human-machine interface 300 includes a plurality of curves or profiles. The human-machine interface 300 includes a display 301 that shows a molding-machine injection profile 302, and includes a point-manipulation toolbar 304 associated with the molding-machine injection profile 302. The human-machine interface 300 includes a molding-machine hold profile 306, and includes a point-manipulation tool bar 308 associated with the molding-machine hold profile 306. The human-machine interface 300 also includes a profile-properties panel 310 that indicates properties of the molding-machine injection profile 302 and the molding-machine hold profile 306. The user uses the control button 210 (shown in FIG. 3) to view or hide the properties panel 310.

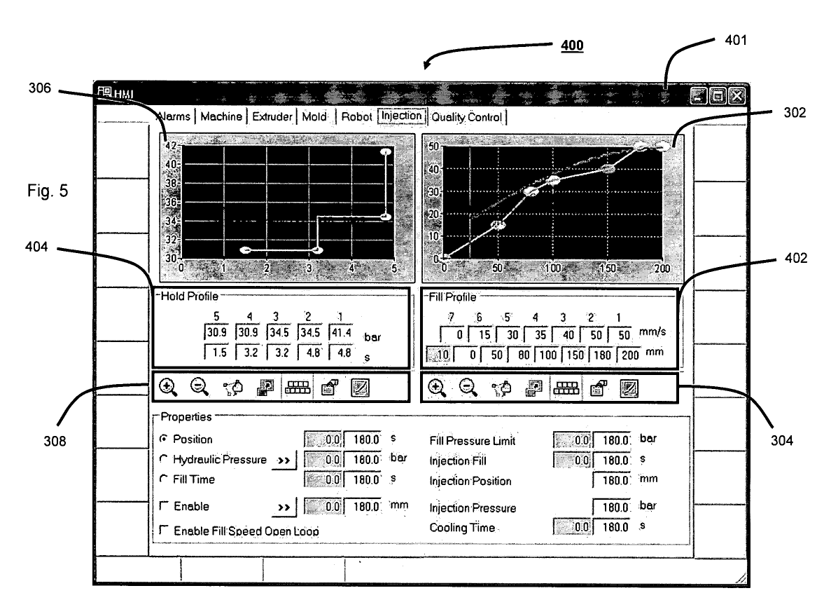

FIG. 5 is a representation of a human-machine interface 400 according to the third embodiment. The human-machine interface 400 includes a display 401, and the display shows a plurality of curves (profiles) and includes tables of emphasized points included in the curves. The human-machine interface 400 includes the molding-machine injection profile 302 of FIG. 4, and includes the point-manipulation toolbar 304 associated with the molding-machine injection profile 302. The human-machine interface 400 includes the molding-machine hold profile 306, and includes the point-manipulation tool bar 308 associated with the molding-machine hold profile 306.

The human-machine interface 400 also includes an injection-profile table 402 (hereafter referred to at the “table” 402) having a set of emphasized points associated with the curve of the molding-machine injection profile 302, and each emphasized point in the table 402 is shown with its respective coordinates. The human-machine interface 400 also includes a hold-profile table 404 (hereafter referred to at the “table” 404) having a set of emphasized points associated with the curve of the molding-machine injection profile 306, and each emphasized point in the table 404 is shown with its respective coordinates. When a user selects an emphasized point from the curve 302, a pair of coordinates in the table 402 becomes emphasized or highlighted (in this case, the coordinates are yellow highlighted). The user can then enter a new number into the highlighted table entry by a keypad is so desired.

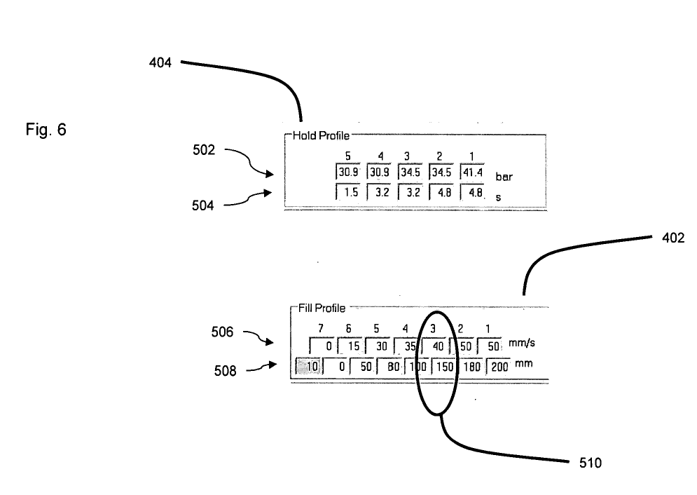

FIG. 6 is a representation of tables 402 and 404 associated with curves displayed in the human-machine interface 400 of FIG. 5. The table 404 includes Y-value coordinates 502 and X-value coordinates 504 of the molding-machine hold profile (molding-machine hold profile) 306 of FIG. 5. The coordinates 502 are shown as a row of pressure values (which is an attribute of the profile 306). The coordinates 504 are shown as time values (another attribute of the profile 306).

The table 403 includes Y-value coordinates 506 and X-value coordinates 508 of the molding machine 101 injection profile (molding-machine injection profile) 302 of FIG. 5. The coordinates 506 are shown as speed values (which is an attribute of the profile 302). The coordinates 508 are shown as a distance of travel of a molding machine 101 screw (not depicted) of the molding machine 101 (another attribute of the profile 302). A table portion 510 is a highlighted portion of the table 402 that corresponds to a user-selected emphasized point.

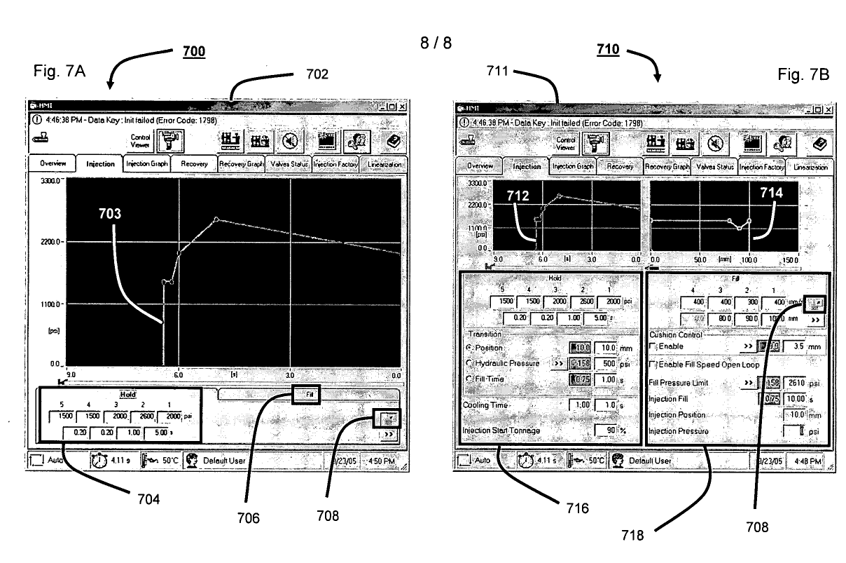

FIGS. 7A and 7B are representations of a human-machine interface 700 and a human-machine interface 710 according to the fourth embodiment and the fifth embodiment respectively.

The human-machine interface 700 includes a display 702 that displays a molding-machine injection curve 703, an injection-profile table 704, a fill tab 706 and a switch-view control button 708. Emphasized points of the curve 703 (shown as circles placed along the curve 703) are shown in a color that matches the curve 703. The table 704 indicates or shows the coordinates associated with the emphasized points of the curve 703. A user may “point and click” the fill tab 706 in order to hide the curve 703 and the table 704 and then reveal a curve and a table that are associated with a hold profile of the molding machine 101. The switch-view control button 708 enables the user to switch between the human-machine interface 700 and the human-machine interface 710.

The human-machine interface 710 reveals more information than the human-machine interface 700. The human-machine interface 710 includes a display 711 that displays an injection-profile curve 712 (which is the curve 703 but shown in a condensed form), a hold-profile curve 714, an injection-profile information panel 716, and a hold-profile information panel 718. The switch-view control button 708 is also included in the human-machine interface 710. The injection-profile information panel 716 shows information pertaining to the injection-profile curve 712. The hold-profile information panel 718 shows information pertaining to the hold-profile curve 714. The switch-view control button 708 enables the user to switch between the human-machine interface 710 and the human-machine interface 700. It is understood that the curves indicated in the human-machine interfaces according to the embodiments of the present invention are molding-machine function curves.

The concepts described above may be adapted for specific conditions and/or functions, and may be further extended to a variety of other applications that are within the scope of the present invention. Having thus described the exemplary embodiments, it will be apparent that modifications and enhancements are possible without departing from the concepts as described. Therefore, what is to be protected by way of letters patent are limited only by the scope of the following claims:

1. A human-machine interface of a molding machine, comprising:
a display of a computer system configured to display;
(i) a molding-machine function curve representing a function of the molding machine; and
(ii) an emphasized point associated with the molding-machine function curve, the emphasized point including a break point being emphasized relative to other break points associated with the molding-machine function curve.

2. The human-machine interface of claim 1, wherein:
the emphasized point is included in a set of emphasized points.

3. The human-machine interface of claim 1, wherein:
the emphasized point is configured to be highlighted.

4. The human-machine interface of claim 1, wherein:
the emphasized point is configured to be emphasized relative to the molding-machine function curve.

5. The human-machine interface of claim 1, wherein:
the emphasized point is configured to be emphasized by a shape indicator, a color indicator and any combination and permutation thereof.

6. The human-machine interface of claim 1, wherein:
the emphasized point is configured to be display manipulatable responsive to user interaction with a point-manipulation mechanism attached to the computer system.

7. The human-machine interface of claim 1, wherein:
the emphasized point is configured to be display manipulatable responsive to user interaction with a point-manipulation mechanism attached to the computer system, the point-manipulation mechanism includes any one of a touch-sensitive screen, a mouse pointer, a point manipulation toolbar and any combination and permutation thereof.

8. The human-machine interface of claim 1, wherein:
the molding-machine function curve includes any one of a molding-machine injection profile, a molding machine hold profile and any combination and permutation thereof.

9. The human-machine interface of claim 1, wherein:
the computer system is configured to use the molding-machine function curve in controlling motion of a movable molding-machine part of the molding machine.

10. The human-machine interface of claim 1, wherein:
the computer system is configured to use the molding-machine function curve in controlling motion of a movable molding-machine part of the molding machine, the movable molding-machine part includes any one of a molding-machine clamp, an injection piston and any combination and permutation thereof.

11. The human-machine interface of claim 1, wherein:
the computer system is configured to use the molding-machine function curve in controlling any one of speed, acceleration, deceleration of a movable molding-machine part of the molding machine.

12. The human-machine interface of claim 1, wherein:
the emphasized point is configured to be displayed in an information panel, the information panel is configured to show coordinates of the emphasized point.

13. The human-machine interface of claim 1, wherein:
the emphasized point is included in a set of emphasized points; each emphasized point of the set of emphasized points has a coordinate in a table; and
the display is configured to display the table.

14. The human-machine interface of claim 1, wherein:
the emphasized point is manipulatable by a control button.

15. The human-machine interface of claim 1, wherein:
the molding-machine function curve is manipulatable by a control button.

16. A molding machine, comprising:
a human-machine interface, including:
a display of a computer system configured to display;
(i) a molding-machine function curve representing a function of the molding machine,
(ii) an emphasized point associated with the molding-machine function curve, the emphasized point including a break point being emphasized relative to other break points associated with the molding machine function curve.

17. The molding machine of claim 16, wherein;
the emphasized point is included in a set of emphasized points.

18. The molding machine of claim 16, wherein:
the emphasized point is configured to be highlighted.

19. The molding machine of claim 16, wherein:
the emphasized point is configured to be emphasized relative to the molding machine function curve.

20. The molding machine of claim 16, wherein:
the emphasized point is configured to be emphasized by a shape indicator, a color indicator and any combination and permutation thereof.

21. The molding machine of claim 16, wherein:
the emphasized point is configured to be display manipulatable responsive to user interaction with a point-manipulation mechanism attached to the computer system.

22. The molding machine of claim 16, wherein:
the emphasized point is configured to be display manipulatable responsive to user interaction with a point-manipulation mechanism attached to the computer system, the point-manipulation mechanism includes any one of a touch-sensitive screen, a mouse pointer, a point manipulation toolbar and any combination and permutation thereof.

23. The molding machine of claim 16, wherein:
the molding-machine function curve includes any one of a molding-machine injection profile, a molding machine hold profile and any combination and permutation thereof.

24. The molding machine of claim 16, wherein:
the computer system is configured to use the molding-machine function curve in controlling motion of a movable molding-machine part of the molding machine.

25. The molding machine of claim 16, wherein:
the computer system is configured to use the molding-machine function curve in controlling motion of a movable molding-machine part of the molding machine, the movable molding-machine part includes any one of a molding-machine clamp, an injection piston and any combination and permutation thereof.

26. The molding machine of claim 16, wherein:
the computer system is configured to use the molding-machine function curve in controlling any one of speed, acceleration, deceleration of a movable molding-machine part of the molding machine.

27. The molding machine of claim 16, wherein:
the emphasized point is configured to be displayed in an information panel, the information panel is configured to show coordinates of the emphasized point.

28. The molding machine of claim 16, wherein:
the emphasized point is included in a set of emphasized points, each emphasized point of the set of emphasized points has a coordinate in a table; and
the display is configured to display the table.

29. The molding machine of claim 16, wherein:
the emphasized point is manipulatable by a control button.

30. The molding machine of claim 16, wherein:
the molding-machine function curve is manipulatable by a control button.

31. A computer system of a molding machine, comprising:
a human-machine interface, including:
a display configured to display;
(i) a molding-machine function curve representing a function of the molding machine; and
(ii) an emphasized point associated with the molding-machine function curve, the emphasized point including a break point being emphasized relative to other break points associated with the molding-machine function curve.

32. The computer system of claim 31, wherein:
the emphasized point is included in a set of emphasized points.

33. The computer system of claim 31, wherein:
the emphasized point is configured to be highlighted.

34. The computer system of claim 31, wherein:
the emphasized point is configured to be emphasized relative to the molding-machine function curve.

35. The computer system of claim 31, wherein:
the emphasized point is configured to be emphasized by a shape indicator, a color indicator and any combination and permutation thereof.

36. The computer system of claim 31, wherein:
the emphasized point is configured to be display manipulatable responsive to user interaction with a point-manipulation mechanism attached to the computer system.

37. The computer system of claim 31, wherein:
the emphasized point is configured to be display manipulatable responsive to user interaction with a point-manipulation mechanism attached to the computer system, the point-manipulation mechanism includes any one of a touch-sensitive screen, a mouse pointer, a point manipulation toolbar and any combination and permutation thereof.

38. The computer system of claim 31, wherein:
the molding-machine function curve includes any one of a molding-machine injection profile, a molding machine hold profile and any combination and permutation thereof.

39. The computer system of claim 31, wherein:
the computer system is configured to use the molding-machine function curve in controlling motion of a movable molding-machine part of the molding machine.

40. The computer system of claim 31, wherein:
the computer system is configured to use the molding-machine function curve in controlling motion of a movable molding-machine part of the molding machine, the movable molding-machine part includes any one of a molding-machine clamp, an injection piston and any combination and permutation thereof.

41. The computer system of claim 31, wherein:
the computer system is configured to use the molding-machine function curve in controlling any one of speed, acceleration, deceleration of a movable molding-machine part of the molding machine.

42. The computer system of claim 31, wherein:
the emphasized point is configured to be displayed in an information panel, the information panel is configured to show coordinates of the emphasized point.

43. The computer system of claim 31, wherein:
the emphasized point is included in a set of emphasized points, each emphasized point of the set of emphasized points has a coordinate in a table; and
the display is configured to display the table.

44. The computer system of claim 31, wherein:
the emphasized point is manipulatable by a control button.

45. The computer system of claim 31, wherein:
the molding-machine function curve is manipulatable by a control button.

46. A method of a human-machine interface of a molding machine, comprising:
displaying a molding-machine function curve representing a function of the molding machine; and
displaying an emphasized point associated with the molding-machine function curve, the emphasized point including a break point being emphasized relative to other break points associated with the molding-machine function curve.

47. The method of claim 46, wherein:
the displaying of the a molding-machine function curve occurs on a display of a computer system; and
displaying of the emphasized point occurs on the display of the computer system.

48. The method of claim 46, wherein:
the emphasized point is included in a set of emphasized points.

49. The method of claim 46, wherein:
the emphasized point is configured to be highlighted.

50. The method of claim 46, wherein:
the emphasized point is configured to be emphasized relative to the molding-machine function curve.

51. The method of claim 46, wherein:
the emphasized point is configured to be emphasized by a shape indicator, a color indicator and any combination and permutation thereof.

52. The method of claim 46, wherein;
the emphasized point is configured to be display manipulatable.

53. The method of claim 46, wherein:
the molding-machine function curve includes any one of a molding-machine injection profile, a molding machine hold profile and any combination and permutation thereof.

54. The method of claim 47, wherein:
the computer system is configured to use the molding-machine function curve in controlling motion of a movable molding-machine part of the molding machine.

55. The method of claim 47, wherein:
the computer system is configured to use the molding-machine function curve in controlling motion of a movable molding-machine part of the molding machine, the movable molding-machine part includes any one of a molding-machine clamp, an injection piston and any combination and permutation thereof.

56. The method of claim 47, wherein:
the computer system is configured to use the molding-machine function curve in controlling any one of speed, acceleration, deceleration of a movable molding-machine part of the molding machine.

57. The method of claim 46, wherein:
the emphasized point is configured to be displayed in an information panel, the information panel is configured to show coordinates of the emphasized point.

58. The method of claim 46, wherein:
the emphasized point is included in a set of emphasized points, each emphasized point of the set of emphasized points has a coordinate in a table.

59. The method of claim 46, wherein;
the emphasized point is manipulatable by a control button.

60. The method of claim 46, wherein:
the molding-machine function curve is manipulative by a control button.
